(19) United States
(12) Patent Application Publication
(10) Pub. No.: US 2023/0160193 A1
(43) Pub. Date: May 25, 2023

(54) SHOWER HEAD

(71) Applicant: HUMAN CENTRIC FZCO, Dubai (AE)

(72) Inventor: Jacques Joseph NAMMOUR, Mar Takla (LB)

(73) Assignee: HUMAN CENTRIC FZCO, Dubai (AE)

(21) Appl. No.: 17/995,312

(22) PCT Filed: Apr. 2, 2021
(86) PCT No.: PCT/IB2021/052771

§ 371 Date: Oct. 3, 2022

(51) Int. Cl. E03D 9/08; B05B 1/18; B05B 7/04; E03D 9/03

(52) U.S. Cl. CPC E03D 9/085; B05B 1/18; B05B 7/0416; E03D 9/03

(57) ABSTRACT

The present invention relates to a shower head which comprises a dispenser for optionally or selectively dispensing a fluid additive such as soap, simultaneously or separately with the water. The invention discloses an innovative mechanism using optimized fluid mechanics for spraying water or cleansing solution for a more hygienic and overall cleansing experience.

### FIELD OF THE INVENTION

The present invention relates to a device and system for dispensing a fluid additive simultaneously or separately with water from a shower spray and in particular for use as a bidet shower or bidet sprayer.

### BACKGROUND OF THE INVENTION

In a large number of countries and in many cultures, the use of a bidet shower is a common practice considered to be essential to cleansing after the use of a toilet for urination or defecation. The bidet shower is also frequently used beyond these cultures for maintaining hygienic cleanliness for the genital and back end areas for both males and females. This practice and use is primarily prevalent in Muslim countries, where the bidet shower is commonly known as a shattaf bidet spray, and Asian cultures. For the purposes of this disclosure, the terms shattaf, bidet spray, bidet shower or any combination thereof, may be used interchangeably to describe the same item and without segregation or differentiation between one or the other.

A bidet shower is often available as an attachment in both private and public bathrooms or washrooms, and conveniently placed for easy access and use while seated on a toilet. The use of this device is considered to be of the highest hygienic importance and is indispensable in many countries and cultures. These sprays, if not already available, can easily and conveniently be installed on an already existing toilet seat and almost any washroom or bathroom.

Whereas the present disclosure defines the device and its use for the specific application on bidet showers, said disclosure is not limited to the example defined herein by the description and claims, and for a person of ordinary skills, it will become apparent that the applicability of the present device and method may extend to other applications including, but not limited to, bath shower heads, kitchen sink shower heads, any sink shower head, gardening shower heads as well as applications in both home, garden, office and various industries. The description herein in no way limits the invention to one or the other applications, but is rather used to better describe certain embodiments of both the device and the method of use of said device in a convenient and exemplary manner.

A bidet shower, as stated above, is a common attachment found in Muslim and Asian cultures where post-urination and post-defecation hygiene is considered of the utmost importance and indispensable. Western cultures preferably rely on the bidet seat, which is generally an oval or rectangular basin located next to a toilet seat and includes a spraying faucet and water temperature and pressure controls. It is worth noting that in most countries, and in particular in cities, where living spaces are becoming smaller due to an increase living demand and less build-up space, the bidet seat, as a separate plumbing fixture, is becoming obsolete as bathrooms become smaller. Furthermore, as a natural result of globalization and migration, there is an increase in the number of people of varying ethnic, religious and racial background, for whom the use of a bidet shower is indispensable, into countries and regions where this device is not readily available. A shower bidet solves the problem of limited space as the same merely requires a hose connected to the toilet seat water container, a shower head and a means of hanging or fixing the system on or in proximity of the toilet seat itself.

The idea of a shattaf already exists for dispensing or spraying water only. None of the prior art however describes, discloses or even teaches for an integrated shattaf that dispenses cleanser such as soap separately or mixed with water,

A number of devices or assemblies have been developed over the years, even patented, for adding or mixing liquid additive with a water stream coming out of a shower head. To date there has been no such system which has been proven to be convenient or practical to be brought into commercial use. Certainly, none have been developed or used as a shattaf.

U.S. Pat. No. 6,926,212 discloses soap dispensing devices for adding liquid soap to water as it travels to a showerhead. The said device includes a pump which is positioned in a housing and an actuator for actuating the pump. The pump is coupled to a soap reservoir whereby actuating the pump will draw the soap into the water inlet thus allowing for the soap to mix with the water on its way out the shower head. This system is rather bulky and has limited applications in particular as applied to a bidet shower. The system requires a complex installation process and may not be applicable to limited spaces such as those discussed previous sections.

U.S. Pat. No. 5,333,789 proposes an insert for dispensing a liquid additive in a water inlet stream. The insert is divided into two separate chambers and when activated, the pressure pushes the liquid additive out into the flow of the water. The system gives the user partial control over the dispensing in particular the quality of the liquid additive, since after every use, the said liquid additive may mix with a small amount of water.

U.S. Pat. No. 4,193,520 discloses a complete shower head assembly having an integral means for introducing soap or the like into the water stream and having a quick on/off feature. The assembly includes an integral narrowed section in the inlet tube to provide a Venturi effect to draw soap into the stream. A number of other proposed ideas, namely U.S. Pat. Nos. 4,651,930, 4,121,773, 4,651,930, 3,764,074 are based on a similar concept of pushing a liquid additive which resides is located in an external compartment by the use of pressure as the primary mechanism of introducing said liquid additive into the water flow.

Another prior art is GB2445736 which discloses a shower head comprising a dispenser whereby said dispenser is inserted into the handle of said showerhead. The disclosure is developed for use by elderly and infirm persons, to help them take a comfortable and safe shower. The proposed system requires the user to hold the shower head with one hand and control the dispenser with the other hand.

The various devices or systems disclosed in the prior art require complicated, cumbersome or excess space for mechanisms which may not be economically, ergonomically or even functionally feasible or practical, let alone as an improvement on existing bidet showers. Furthermore, the more compact or contained systems are based on a mechanism which provides little control or are inconvenient for use. Even further, none of the systems or devices disclosed in the prior art provide for a cleaning system which does not require the user to use at least a hand in mechanically wiping clean the desired area.

The disclosure below proposes to address all of these defects and in particular the ergonomics and the innovative ability of cleansing simply by using the pressure of the showerhead to dislodge (i.e. fecal matter) or deeply cleanse the desired parts of the body.

### SUMMARY OF THE INVENTION

In accordance with the present invention, a displacement system is provided for introducing cleanser into the water jet stream flowing through a shower hose and out of a shower head. The cleanser may be in the form of liquid, gel, dissolvable pellets, or any other state amenable to being drawn by negative pressure and dissolving in water. The cleanser of the invention is contained in a cartridge which is an integral part of the present invention, yet the said cartridge is removable, replaceable and/or refillable. The dispenser of the invention introduces the aforementioned cleanser by toggling a switch which opens or closes a means by which the cleanser is mixed with water. The said cartridge is adapted to be inserted between a shower line and shower head, and in one embodiment in the handle of the shower head itself

In a preferred embodiment of the present invention, a shower head is attached to a shower arm which in turn is attached to a shower line. Said shower arm is composed of a plurality of compartments whereby at least one of said compartments is set to house a cartridge or pouch wherein said cartridge or pouch contains said cleanser. The compartment in question is sealed off from the flow of water when the toggle switch is activated in one position and the compartment in question is open to the system when the switch is toggled in another position, thus allowing the cleanser to be mixed with the water.

As a result, the mixed water with the cleanser is sprayed from the shower head and can provide one handed use of the shattaf, without the need to use the other hand for wiping or cleaning. It is well known that the action of soap and water is the main means of cleansing and the proposed device of the present invention will provide cleansing of the specific parts easily and allow for a hygienic state of the private areas following urination, defecation or for mere hygienic cleansing purposes.

### BRIEF DESCRIPTION OF THE DRAWINGS

FIG. 1 is a full frontal external view of a shattaf bidet sprayer with the dispenser (not shown) and the toggle switch.

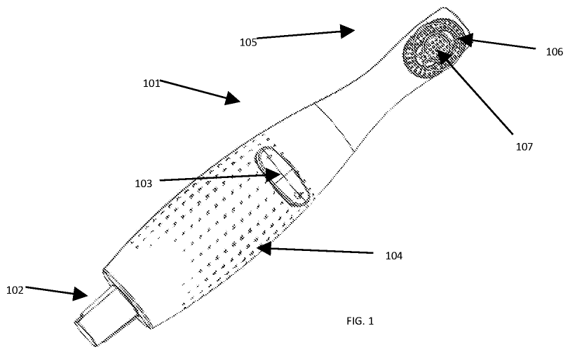

FIG. 2 is a full rear external view of a shattaf bidet sprayer showing the location where the cartridge or pouch is located.

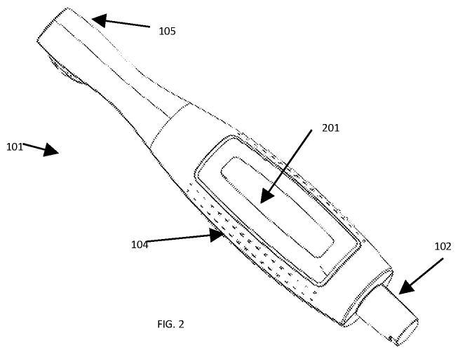

FIG. 3 represents a full internal view of the shower handle showing the different parts for enabling the proposed system.

FIG. 4 is a representation of the internal back part of the shattaf and the relevant elements thereof.

FIG. 5 is a representation of the internal system through which the water and cleanser circulate and flow as well as mixed.

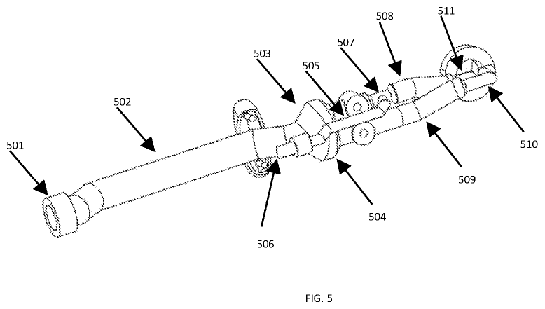

### DETAILED DESCRIPTION OF THE INVENTION

In a preferred embodiment of the present invention, the dispenser is comprised of a shower head 105, a shower arm 104 and at least one button or switch 103. The dispenser is connected to the water source via a shower line 102. The dispenser also comprises at least one compartment for storing a cartridge, pouch or any such similar container.

For further descriptions, the preferred embodiment used herein will be the one where the dispenser is a unit comprising the different parts of shower head 105, shower arm 104 and the said at least one button 103. The definitions and descriptions provided herein for the mechanism by which the cleanser is found in the present embodiment and the mixing between said cleanser and water are applicable to this preferred embodiment as well as the alternate embodiment as can be seen hereinafter to a person of skills.

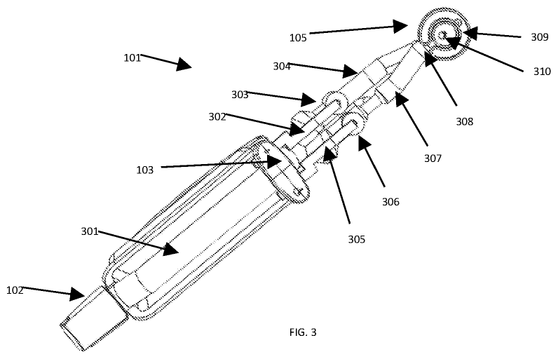

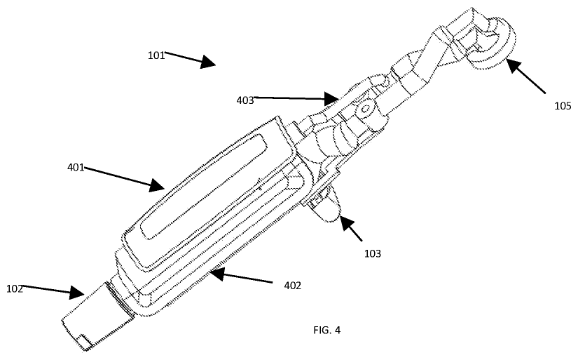

In a preferred embodiment, the shower arm 102 is made from non-corrosive material or coated as needed to prevent corrosion. The shower arm 104 preferably has an elongated hollowed shape 101 with openings at each end of said shape. Since the shower arm connects the shower line 102 to the shower head 105, water flows into the shower arm from the opening at the said end which is attached to the shower line 102 and through a plurality of tubes (as shown in FIGS. 3 and 4) when the toggle switch 103 is pressed for the function to release a water jet or spray from the shattaf 101 through the connected aerator.

In a preferred embodiment of the present invention, the hollowed interior of the shower arm 101 contains a recipient 201 in which a removable cartridge or pouch 402 can be inserted. Said recipient 201 is an integral part of the shower arm 101. Said recipient 201 has also an elongated hollowed shape but is of smaller dimensions than the shower arm 101 itself.

In the present embodiment, the said removable cartridge or pouch 402 is connected to the internal tubing system via the opening 506 of tube 505. The connection is made to be sealed to prevent leakage of soap, water, air or any mix thereof. The seal provides for a closed and contained system for an improved performance of the device disclosed herein.

In a preferred embodiment, the shower arm 101 has at least one button or switch 103 on the upper or lower side of said shower arm 101, and even, conceivably with minor variations in design, on any facet which allows for ergonomic use of said button. Said at least one button 103 functions to perform one of the following two tasks when pressed: allow only water to flow through the shower arm 101 in the dedicated tube 304 and out the shower head 105 and the dedicated spray holes (aerator) 106; or, allow water to flow through the shower arm 101 in the dedicated tube 304 while opening the valve 306 for the recipient 201 simultaneously, thus mixing the content of the container or pouch 402 with the water at the junction 308 prior to the mixture coming out of the shower head 105 and through the spray hole 107 (aerator). In the present embodiment, it is to be made clear that there are two sets of spray holes or two separate aerators; these are: 106 through which only water sprays and 107 from which the mixture of water and cleansing composition sprays out.

In a preferred embodiment both the spray holes or aerators, 106 and 107, are designed to help control both the pressure of the sprays and the consistency of the mixture to provide for a much higher cleansing experience and outcome.

In a preferred embodiment of the present invention, the recipient 201 can hold a replaceable or refillable cartridge or pouch (or any such container) 402 which contains an additive such as soap in the form of liquid, or gel or dissolvable pebbles or any other water miscible cleansing composition which is adequate for the purposes of the present disclosure. The said cartridge is adapted to fit in its designated space 402. The cartridge may be composed. of any material, but is preferably composed from flexible material in order to ensure that the cleanser is adequately and completely utilized when expelled into the water stream via a Venturi effect. The cartridge may be secured in its designated place by a multitude of systems such as twisting, turning, capping, clicking, etc. with a seal lodging it in place to dispense into the relative tube 505. The cartridge may be replaced by removing the cover 201, pulling the empty cartridge out and re-inserting a new cartridge.

The connection where the cartridge dispenses the cleanser into the tube 506 may be a sharp point with openings to break the seal of a new cartridge and allow the flow of the cleanser once the Venturi effect is activated.

In brief, the flow in the proposed system is as follows. A water hose is connected to the device of the invention at 501, which is the main tube of the system. Once the water from the source is on, the tube 502 will always contain water under pressure of a range of 1.5 to 5.0 bars. Furthermore, the connecting tubes 503 and 504 will also contain water when the device is connected to a hose and the water source is turned on. The water will fill up these spaces and stop at the valves inside 303 and 306, which valves are controlled by the levers 302 and 305, respectively and which in turn are activated by the switch 103 depending on which side of said switch is pressed. In a different embodiment where the switch 103 is in fact two separate buttons, the same effect can be obtained from pressing one button or the other. For the purposes of this disclosure and based on the supporting figures, a single switch which may be pressed at either end is presented.

In a further embodiment, there are included springs or spring-acting parts lodged within the parts 303 and 306 which allow for the levers 302 and 305 to go back to their initial position once the switch 103 is depressed. Said springs are designed in an innovative manner to withstand the pressure of the water flowing through them and are capable to return to their resting position despite the water pressure once the switch is depressed. The springs, their position and mode of action are innovative in order to enable the smooth and flawless execution of their role when activated and when the related switch is depressed.

Depending on how the said switch 103 is pressed, either only water is sprayed or a mixture of water and cleanser is sprayed.

The diameter of tube 502 is crucial in maintaining the adequate pressure inside the system in this section of the device. The diameters of the rest of the tubes within the system are also critical in achieving the desired flow rate and outflowing pressure. These have been studied to ensure the optimal functioning of the device and its function. If the diameters are larger than required, then the water or mixed water/cleanser jet will be too low to be effective; and if the diameters are smaller, then this will result in excessive internal pressure which may affect the integrity of the device as well as cause the release of the water or mixed water/cleaner jet at too high of a pressure to be usable.

The said diameters vary depending on the overall size of the device, however the resulting spray coming out of the device must be appropriate for doing the desired function of cleaning without the need to use a hand to wipe and without excess pressure which may be painful and cause splatter.

It was deemed indispensable to refrain from defining the specific diameters, lengths, shape and connection style of the different tubing parts since these will vary depending on the overall size of the device. In addition, since the proposed device may be used in multiple industries and for varying purposes as disclosed herein above, it is submitted that the relative ratios between the different parts is what matters and these are assessed for each type of device as needed based on a specific formula which results in the desired effect and outcome.

In a further embodiment, the shape of said tubes may be cylindrical in form or adopt a slightly tapering conical shape at specific junctions to enable a preferred performance and prevent return flow, bubble formation, which may block adequate flow or repeated use of the device. It is submitted herein that the size and shape of the tubing at various positions of the system are critical and crucial and contribute to a key innovative element, not disclosed or cited anywhere in the prior art.

Following up on the flow in the system, if the user wishes to spray only water, then the switch 103 is pressed in the desired direction to activate lever 302 which will open the valve located inside 303. The water will then flow freely through 303 and tube 304 and out the opening 310 and spray out from 107. The diameters of the different components are specific to the size of the device to ensure the adequate pressure coming out of the head 107. Once the user is done rinsing, the user releases the switch which will result in the valve inside 303 to close again and hold the water behind it.

If the user wishes to spray a mixture of water and cleanser, then the lever 103 is pressed in the desired direction to activate lever 305 which will open the valve located inside 306. The water will then flow through the opening at 303. As the water flows through the tube section 507, it will create a vacuum inside tube 505. The vacuum creates a negative pressure which, based on the Venturi principle, will draw or aspirate cleanser form the cartridge 402 through the opening 506 and through the tube 505 which will then mix with the water at 507. The mixed water/cleanser solution will then continue to flow through tube 508 and into the shower head through tube 511. The mixed water/cleanser will exit through the opening 309 and spray out through 106.

In order to enable this process, it is submitted that the relative sizes and shapes of various sections of the tubing play an important role in ensuring constant flow at a desired pressure to obtain the necessary spray in the right amount and pressure to achieve the purpose of the invention.

To rinse the mixed water/cleanser, the user then releases the switch which will close the valve inside 305 thus canceling the Venturi effect and stop the flow of the cleanser into 507. The user then presses on the switch 103 in the direction to activate lever 302 to go through the previously described flow to spray water only. Again, the tapered conical shape at the junction plays a critical role in maintaining the pressure when open and preventing an air bubble from blocking the flow once the action is terminated.

When the switch 103 is pressed to allow the cleanser to flow, the water passing through the tube 307 creates a negative pressure or vacuum in tube 403, creating a Venturi effect using the Bernoulli principle, thus drawing the cleanser through the tube 403 which then mixes with the water upstream of tube 307. The mixed water and cleanser then proceeds under the water pressure to flow through the system and spray out the shower head 105 from the opening 310 spraying out the holes 107. As a result, the user of said shattaf will hygienically cleanse the soiled parts following urination or defecation or for general cleansing. By toggling the switch back to the water only function, the user of the shattaf can rinse the cleansing mixture off.

It is well known in the art and in practical use of showerheads, regardless of their intended use as a shattaf, as disclosed in the present embodiment of the current description or a showerhead for taking showers, or in the use in the kitchen, or hospitals, etc. cleaning requires the use of mechanical cleansing in addition to spraying water and or detergent. So for example, under the shower, a user needs to scrub down with the hands, maybe even using a device such as a sponge to mechanically remove dirt, apply shampoo or soap across the desire area to be cleansed.

In a similar manner, and going back to the concept of a shattaf, a person skilled in the art knows that a shattaf spraying water alone is not enough to provide the desired hygienic cleanliness. A user is obliged to use at least one hand, a cloth or a sponge in order to properly and thoroughly clean the desired area. Even bidet's fail to adequately cleanse without the need for the user to mechanically wipe away stuck fecal matter, blood or other deposits. It is the assertion herein that this defect is resolved with the proposed showerhead and system thereof.

Traditional and existing shower heads use a direct tube for water flowing from the source at one end of a showerhead and through the dispensing jets or outlet at another end of said showerhead. The flow of the water may be controlled, i.e. released or stopped, using a lever which opens or closes a valve lodged within the tube. The system of the proposed invention proposes a plurality of tubes with a plurality of valves to control the flow, the pressure of the flow, be it water alone or a mixture of water and cleanser, and the pressure of the outgoing jet directed to the area to be cleansed.

According to studies performed to identify the pressure at which the water and water/cleanser mixture should be sprayed to adequately clean by removing any attached fecal matter, blood, or other it was found that the incoming pressure into the shattaf should be around 3 bar between. Accordingly, based on calculations to obtain said pressure, a study was developed to determine the different diameters of said plurality of tubes to ensure that this pressure is delivered. Anything different will result either in lower pressure which will fail in providing the adequate cleaning required; or in higher pressure which may cause pain or random splattering, which will also result in inadequate cleansing.

In the present embodiment, it was thus determined what the diameter range for the tube 301 should be, as well as the range of diameters for tubes 304, 307 and 308. In addition, the studies resulted in a range of acceptable diameters for the opening releasing water only 310 as well as that of the opening releasing the mixture of water and cleanser 309.

While certain embodiments were disclosed in the description, these are merely used as examples to clarify the device and system of the invention. These are not to be considered as limiting to one or other type of device or system or cleansing means. The detailed description does not limit the scope of the invention to the design shown in the figures, as again, this was merely used for illustrative purposes.

What is claimed is:

1. A shower spray which comprises:
a water inlet 102,
a shower arm 104, comprising a recipient 201, a recipient cover 401, at least one switch button 103, a plurality of tubes, a plurality of levers, a plurality of valves and a plurality of springs,
a cartridge 402,
a shower head 105 comprising a plurality of sprayer holes as aerators (106, 107),
wherein said plurality of tubes comprise a primary in-flowing water tube 301, which branches into at least two separate tubes, wherein one of said at least two separate tubes is for water use only 304 and another of said at least two separate tubes is for mixed water and cleanser use 307 and a tube 403 for the flow of the cleanser from the cartridge 402 to mix with the water in tube 307,
wherein at least the tube 403 connecting the cartridge 402 with the tube where the water flows 508 has a conical shape tapering at the junction 507 with the tube 508, wherein the said plurality of levers are controlled by the said switch button 103 to activate said plurality of valves and springs, and
wherein the recipient cover 401 is removable and seals the recipient 201 which contains the cartridge 402.

2. The shower spray of claim 1 wherein the diameters of said plurality of tubes is defined according to specific ratios and wherein said plurality of tubes may be cylindrical or conical in shape.

3. The plurality of tubes according to claim 2, wherein the said ratios and shapes result in a pressure of water or water and cleanser mixture for use in hygienic cleaning.

4. The shower spray of claim 1 wherein the shower head and the shower arm may be detachably attached together.

5. The shower spray of claim 1, wherein said cartridge 402 may be disposable and replaceable.

6. The shower spray of claim 1 wherein the recipient cover 401 may be clear.

7. The shower spray of claim 1 where the cartridge contains a cleansing material.

8. The shower spray of claim 7 wherein the cleansing material may be a cleansing liquid, foam, gel or water soluble solid.
